(19) United States
(12) Patent Application Publication
(10) Pub. No.: US 2004/0178127 A1
(43) Pub. Date: Sep. 16, 2004

(54) Centrifugal drum for a separator

(75) Inventor: Willi Niemerg, Oelde (DE)

Correspondence Address: BARNES & THORNBURG, 750-17TH STREET NW, SUITE 900, WASHINGTON, DC, 20006, US

(73) Assignee: Westfalia Separator AG

(21) Appl. No.: 10/798,265

(22) Filed: Mar. 12, 2004

(30) Foreign Application Priority Data
Mar. 12, 2003 (DE) 103 11 168.9-23

(51) Int. Cl. B07B 1/00

(52) U.S. Cl. 209/1

(57) ABSTRACT

A centrifugal drum for a separator having a vertical axis of rotation, including a drum bottom part and a drum cover fastened to the drum bottom part by a locking ring. Also included is a centering ring arranged between the drum bottom part and the drum cover such that while the centering ring is being pretensioned, it sealingly and centeringly braces the drum bottom part and the drum cover relative to one another.

The invention relates to a centrifugal drum for a separator, which preferably has a vertical axis of rotation and a drum bottom part and a drum cover which is fastened to the drum bottom part by means of a locking ring.

A centrifugal drum of the above-mentioned type is know from German Patent Document DD 287 147. Accordingly, a centering cone is constructed between the drum bottom part and the drum cover, which centering cone has the purpose of compensating the extensions of the elements during the rotation of the drum. It is also known from this document to arrange sealing rings between the drum bottom part and the drum cover (in this respect, also see, for example, British Patent Document GB 765,034).

International Patent Document WO 00/53327 replaces known locking rings having a screw thread by a band-type locking ring which is arranged in a sloped manner with respect to the axis of rotation or non-concentrically between the drum bottom part and the drum cover.

Concerning the state of the art, German Patent Documents DE 2 328 346 A and DE 818 023 C, Swiss Patent Document CH 325207 and German Patent Document DE 196 09 353 C1 are also mentioned.

It is an object of the invention to further develop a centrifugal drum of the above-mentioned type such that the drum cover can be centered at the drum bottom part by means of simple devices.

The invention achieves this task by means of the object of claim 1.

Accordingly, while being pretensioned (for example, deformed), a centering ring is arranged between the drum bottom part and the drum cover in such a manner that it braces the drum bottom part and the drum cover relative to one another in a sealing and centering manner.

As a result of this measure, a centering cone or a high-expenditure clamping between the drum cover and the drum bottom part for the purpose of a centering can be eliminated and can be replaced by a cost-effective centering ring, particularly made of an elastic material, such as rubber.

Simultaneously, a reliable sealing-off of the centrifugal drum is implemented in the area between the drum bottom part and the drum cover. This also reduces the risk of corrosion, particularly in the area of the thread between the locking ring and the centrifugal drum. Since no additional constructive measures are required for the centering on the drum bottom part, the tension level in the drum bottom part is lowered by the larger wall thickness which can be implemented.

According to a preferred variant, the drum cover engages in the drum bottom part, and the centering ring is arranged between the outer circumference of the drum cover and the inner circumference of the drum bottom part, in which case, the centering ring is designed such that the centering and sealing effect is maintained in the operation up to the maximal rotational speed. As an alternative, embodiments are also conceivable in which the drum bottom part engages from below in the drum cover, although this type of construction is not very customary.

While being axially pretensioned, the centering ring is arranged, particularly in an elastic manner, between the outer circumference of the drum cover and the inner circumference of the drum bottom part in order to implement the centering and sealing effect in a simple manner.

An inner collar is expediently shaped to the inner circumference of the upper ring section of the drum bottom part, on which collar a correspondingly complementarily shaped collar rests which is situated on the outer circumference of a lower ring section of the drum cover. In addition, when the axis of rotation is vertical, a pressure element, particularly a ring disk, preferably acts upon the centering ring from above or below, which presses the centering ring onto the a collar at the drum cover or at the drum bottom part. In this manner, the locking ring can exercise an axial compression force upon the centering ring made of an elastic material.

Additional advantageous further developments are indicated in the subclaims.

In the following, the invention will be described in detail by means of embodiments with reference to the drawing.

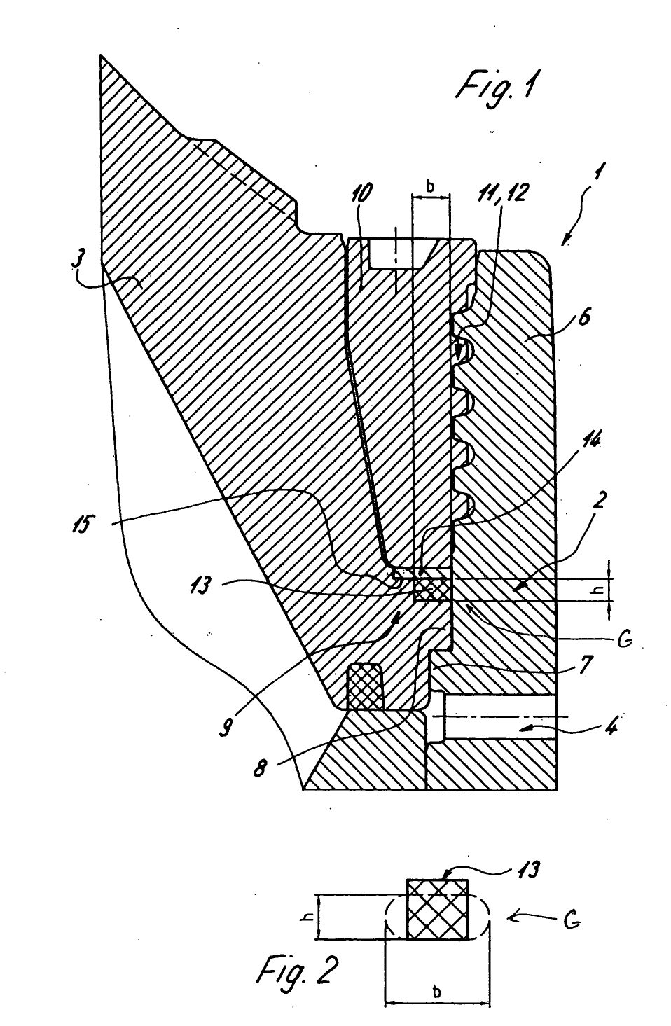

FIG. 1 is a sectional view of the contact area between the bottom part and the cover of a centrifugal drum of a separator;

FIG. 2 is a sectional view of a centering ring before and after the installation.

The following description relates to separators with a vertical axis of rotation. Terms like “above” or “below” relate to this installation situation, but should not be understood to be limiting.

The centrifugal drum 1 of the separator with a preferably vertical axis of rotation has a drum bottom part 2, in whose upper circumferential area a drum cover 3 or a drum top part engages.

In its upper circumferential area illustrated in FIG. 1, the drum bottom part 2 is further developed in a ring shape or cylindrical shape above solids discharge openings 4. The remaining shaping of the drum bottom part 2 is arbitrary; that is, in the downward direction, the drum bottom part 2 may, for example, have a conical or cylindrical (“can-type”) construction.

An inner collar 7 is molded to the inner circumference of the upper ring section 6 of the drum bottom part 2. A correspondingly complementarily shaped collar 8 on the outer circumference of a lower ring section 9 of the drum cover 3, which otherwise is conical at least in sections in the upward direction, rests on this collar 7.

The locking of the drum cover 3 on the drum bottom part 2 takes place by means of a locking ring 10 which has an external thread 11, by means of which it is screwed from above into an internal thread 12 of the drum bottom part 2, and which, among other things, has the purpose of fixing the drum cover 3 in the axial direction.

Above the outer collar 8 at the drum cover, a centering ring 13 is arranged at the outer circumference of the drum cover.

This particularly advantageous centering ring 13, which should be stressed in comparison to the state of the art, consists of an elastically deformable material, particularly of rubber. It is deformed or pretensioned by axial force or pressure. This takes place in that the locking ring 6 presses from above by way of a ring disk 14 onto the centering ring 13 so that the latter is situated, while being compressed, in an elastic and quasi “pretensioned” manner between the drum bottom part 2 and the drum cover 3 and, in this fashion, not only reliably seals off the gap between these elements of the width b, but braces the drum cover 3 and the drum bottom part 2 with respect to one another in the radial direction and thus seals off the latter relative to one another and centers them relative to one another.

In this case, the centering ring 13 is dimensioned and is acted upon by pressure force such that this effect is maintained also in the operation up to the highest rotational speeds, so that the drum bottom part and the drum cover 3 are still centered relative to one another and sealed off also in this operating condition despite their different expansion behavior.

Here, the ring disk 14 is dimensioned such that, on the one hand, it almost completely covers the gap in the upward direction and, on the other hand, rests on another collar-type step 15 of the drum bottom part in the inward direction.

By dimensioning the width b and the height h of the space for the centering ring 13 and by dimensioning and selecting the material of the centering ring 13, the radial spring effect of the centering ring 13 is adjusted such that the desired effect is achieved or that the centering and sealing effect in the operation is maintained to the maximal rotational speed of the separator. As an example, FIG. 2 illustrates the deformation of the centering ring 13 during the installation (previously: solid line; afterwards, during the operation, at a maximal rotational speed and with an expansion of the drum bottom part: broken line). The centering ring 13 is therefore deformed at the level H. For this reason,—because of its pretensioning and its spring effect—when the drum bottom part 2 expands, the centering ring 13 can expand and widen beyond the width B, so that it carries out its sealing and centering function over the entire rotational speed range of the separator.

### List of Reference Symbols

centrifugal drum 1

drum bottom part 2

drum cover 3

solids discharge openings 4

upper ring section 6

inner collar 7

outer collar 8

lower ring section 9

locking ring 10

external thread 11

internal thread 12

centering ring 13

ring disk 14

step 15

width b

height h

1. Centrifugal drum (1) for a separator, having a vertical axis of rotation and having
a) a drum bottom part (2) and a drum cover (3) which is fastened to the drum bottom part (2) by means of a locking ring (10), characterized in that
b) between the drum bottom part (2) and the drum cover (3), a centering ring (13) is arranged such while being pretensioned that it sealingly and centeringly braces the drum bottom part (2) and the drum cover (3) relative to one another.

2. Centrifugal drum according to claim 1,
characterized in that the drum cover (3) engages in the drum bottom part (3), and in that the centering ring (11) is arranged between the outer circumference of the drum cover (3) and the inner circumference of the drum bottom part (2), the centering ring (13) being designed such that the centering and sealing effect is maintained during the operation to the maximal rotational speed of the separator.

3. Centrifugal drum according to claim 1 or 2,
characterized in that the centering ring (11), while being axially pretensioned, is arranged between the outer circumference of the drum cover (3) and the inner circumference of the drum bottom part (2).

4. Centrifugal drum according to one of the preceding claims,
characterized in that the centering ring (13) consists of an elastically deformable material, particularly of rubber.

5. Centrifugal drum according to one of the preceding claims,
characterized in that the centering ring (13) is elastically arranged between the outer circumference of the drum cover (3) and the inner circumference of the drum bottom part (2).

6. Centrifugal drum according to one of the preceding claims,
characterized in that an inner collar (7) is shaped onto the inner circumference of the upper ring section (6) of the drum bottom part (2), on which collar (7) a correspondingly complementarily shaped collar (8) rests which is situated on the outer circumference of a lower ring section (9) of the drum cover (3).

7. Centrifugal drum according to one of the preceding claims,
characterized in that, in the installed position, a pressure element, particularly a ring disk (14), acts upon the centering ring (13) from above or below, which ring disk (14) presses the centering ring upon a collar at the drum cover (1) or at the drum bottom part (3).

8. Centrifugal drum according to one of the preceding claims,
characterized in that the centering ring (13) is arranged above the outer collar (8) of the drum cover (3).

9. Centrifugal drum according to one of the preceding claims,
characterized in that the ring disk 11 is dimensioned such that, on the one hand, it covers the gap between the inner circumference of the drum bottom part (2) and the outer circumference of the drum cover (3) in the area above the collar (8), and, on the other hand, rests on a step (15) of the drum bottom part in the inward direction.

10. Centrifugal drum according to one of the preceding claims,
characterized in that, by dimensioning the width (b) and the height (h) of the space for the centering ring (13) between the drum bottom part (2) and the drum cover (3) and by dimensioning and selecting the material of the centering ring (13), the radial spring effect of the centering ring (13) is adjusted such that the centering and sealing effect in the operation is maintained to the maximal rotational speed of the separator.
